(19) United States
(12) Patent Application Publication
(10) Pub. No.: US 2019/0339751 A1
(43) Pub. Date: Nov. 7, 2019

(54) SERVER TESTING APPLYING CONTROLLED FLOW AND TEMPERATURE

(71) Applicant: Microsoft Technology Licensing, LLC, Redmond, WA (US)

(72) Inventors: Husam Atallah ALISSA, Redmond, WA (US); David WANG, Redmond, WA (US)

(21) Appl. No.: 15/969,634

(22) Filed: May 2, 2018

(51) Int. Cl. G06F 1/20; G05B 15/02; G05D 22/02; G05D 7/06; G05D 23/19

(52) U.S. Cl. CPC G06F 1/206; G05B 15/02; G06F 2200/201; G05D 7/0676; G05D 23/1917; G05D 22/02

(57) ABSTRACT

A server testing apparatus that exposes an operating server to a configured fluid flow rate (e.g., airflow) and temperature. After the server is docked within the server testing apparatus, a software load is applied to the server to mimic actual operation in the target environment. Then, fluid flow is applied into the inlet of the server at a designated flowrate and temperature. By testing the server for both fluid flowrate as well as temperature in a single apparatus at the same time, significant time may be saved. This is due largely to the fact that the server testing takes significant time to ensure that the server can operate long term in the environment in which that server or similar servers may be installed. Furthermore, the testing more accurately represents the operation of the server in the actual environment, thereby leading to better testing for the server.

### BACKGROUND

Datacenters provide the backbone for storage and processing in a cloud computing environment. Datacenters include a larger number of operating servers. In operation, each server generates heat. Each server includes internal fans that draw airflow through the server to help dissipate heat generated within the server itself. The datacenter also includes cooling systems that provide cooler air to the inlets of the servers, and help to draw heat away from the area immediately surrounding the servers. Thus, datacenter cooling systems, in conjunction with server internal fans, help manage temperatures within the datacenter and servers to be within acceptable levels. Proper cooling ensures that the servers have a proper designed lifetimes, and ensures that the operating environment within the datacenter itself is acceptable.

The datacenter may provide a wide variety of services. These service must often satisfy a certain high level of availability. That is, after all, one of the attributes and benefits of cloud computing. When operating a large datacenter with thousands or millions of servers, the failure of a number of servers is inevitable. Accordingly, there is built-in redundancy within a datacenter. Nevertheless, that redundancy can be overwhelmed if server failure occurs at higher rates. Accordingly, to ensure that servers of a particular model or type are going to operate with the desired level of reliability, the server model is first tested prior to installing servers of that model into the datacenter.

Conventionally, server testing comprises two steps. In the first step, the server is placed in a thermal chamber, and a software load is applied to the server. While the server is operating in the thermal chamber, fan data of some of the fans of the server is obtained. The internal fans each have a controller that causes the fan to operate at an appropriate speed given the sensed temperature. The second step is to take the server out of the thermal chamber and hook that server up on a wind tunnel or an airflow bench. The air flow is calculated from the fan data. Then, the wind tunnel or airflow bench is operated to provide that calculated airflow. Each step may take a matter of hours to ensure testing over a longer period of time. Furthermore, the tests are performed for each server model that is to be deployed in the datacenter.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to a server testing apparatus that is able to test a server's operation in an environment similar to a target environment in which that server or similar servers are to operate. For instance, a sample server of a particular server model may be tested to given assurance that servers of that same server model will operate properly in a target environment. An example of a target environment is a datacenter, in which case the server testing apparatus simulates conditions within a datacenter.

In accordance with the principles described herein, a server testing apparatus may expose an operating server to a configured fluid flowrate (e.g., airflow), as well as a configured temperature. After the server is docked within the server testing apparatus, a software load is applied to the server to mimic actual operation in the target environment. Then, fluid flow is applied into the inlet of the server at a designated flowrate and temperature.

By testing the server for both fluid flowrate as well as temperature in a single apparatus at the same time, significant time may be saved. This is due largely to the fact that the server testing takes significant time to ensure that the server can operate long term in the target environment. Thus, rather than have two long tests, a single test may be employed. Furthermore, the testing more accurately represents the operation of the server in the actual target environment, thereby leading to better testing for the server. For instance, fan data can be obtained for the server while the server encounters actual fluid flow and temperature conditions, resulting in more accurate fan data.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a schematic diagram of a server testing apparatus in accordance with the principles described herein;

FIG. 2 illustrates a schematic diagram of a server testing apparatus that represents a more specific example of the server testing apparatus of FIG. 1;

FIG. 3 illustrates a flowchart of a method for testing a server in accordance with the principles described herein; and

FIG. 4 illustrates an example computer system in which the principles described herein may be employed.

### DETAILED DESCRIPTION

At least some embodiments described herein relate to a server testing apparatus that is able to test a server's operation in an environment similar to a target environment in which that server or similar servers are to operate. For instance, a sample server of a particular server model may be tested to given assurance that servers of that same server model will operate properly in a target environment. An example of a target environment is a datacenter, in which case the server testing apparatus simulates conditions within a datacenter.

In accordance with the principles described herein, a server testing apparatus may expose an operating server to a configured fluid flowrate (e.g., airflow), as well as a configured temperature. After the server is docked within the server testing apparatus, a software load is applied to the server to mimic actual operation in the target environment. Then, fluid flow is applied into the inlet of the server at a designated flowrate and temperature.

By testing the server for both fluid flowrate as well as temperature in a single apparatus at the same time, significant time may be saved. This is due largely to the fact that the server testing takes significant time to ensure that the server can operate long term in the target environment. Thus, rather than have two long tests, a single test may be employed. Furthermore, the testing more accurately represents the operation of the server in the actual target environment, thereby leading to better testing for the server. For instance, fan data can be obtained for the server while the server encounters actual fluid flow and temperature conditions, resulting in more accurate fan data.

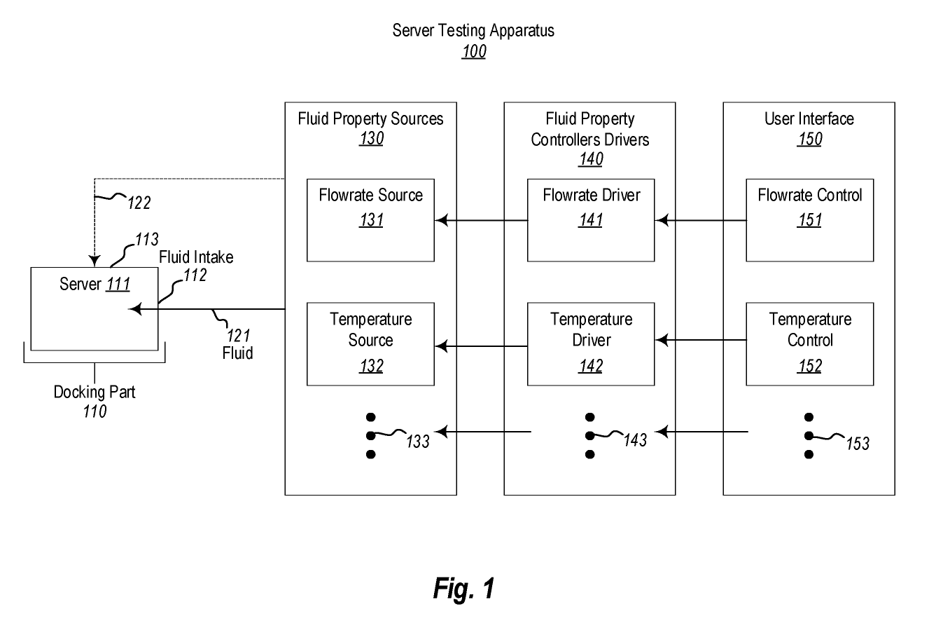

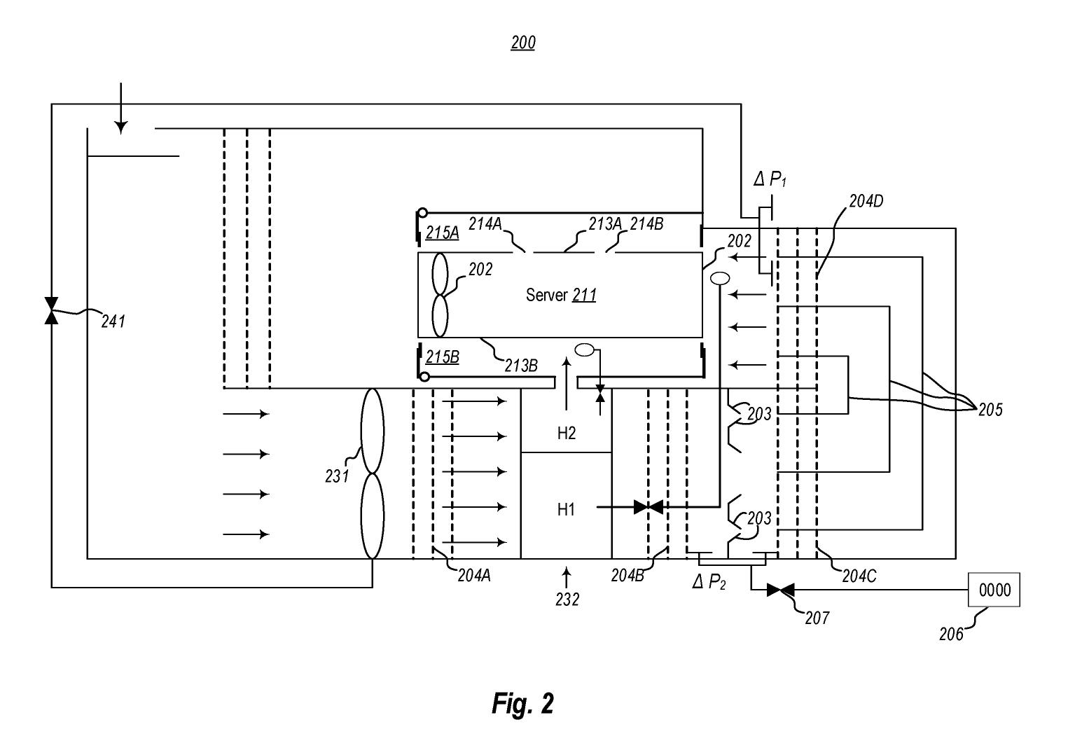

FIG. 1 illustrates a schematic diagram of a server testing apparatus 100 in accordance with the principles described herein. FIG. 1 should be thought of as a symbolic diagram showing how the various components of the server testing apparatus 100 interact. In FIG. 1, no attempt has been made to draw any of the components to scale or even to a correct shape. This is largely because the principles described herein are not limited to a particularly size or shape of the server testing apparatus or its components. Rather, FIG. 1 is provided to conceptually describe the operation of a server testing apparatus. A more concrete example will be given with respect to FIG. 2.

The server testing apparatus 100 includes a docking port 110. The docking port 110 may be docked with a server that is undergoing testing. For instance, the server 111 is illustrated as being docked with the docking port 110. In this description, a server that is docked to the docking port 110 will be referred to as a “docked” server. As used herein, the term “docked” merely means that the server is coupled to the server testing apparatus 100 so as to be able to communicate data. However, to ensure proper placement of the server 111 within the server testing apparatus 100, the docking may fix the server 111 in place within the server testing apparatus 100.

The server testing apparatus 100 may cause the docked server 111 to operate. For instance, the operation may be a predetermined operation, such as the running of a software load. The running of the software load causes the docked server 111 to heat up, and represents an approximation of the software load that the servers of the same model or type as the docked server would experience in a target environment (such as a datacenter).

The docked server 111 includes a fluid intake 112 that is situated to receive fluid 121 having particular properties. The particular properties of the fluid 121 are provided by fluid properties sources 130. The fluid property sources 130 are controlled by fluid property drivers 140. The fluid property drivers 140 may control the fluid properties in response to user interface controls provided by a user interface 150. In one embodiment, the docking port 110 and the fluid property sources 130 with the same capsule.

One property of the fluid may be flowrate. Accordingly, a suitable fluid property source for the flowrate property would be a flowrate source 131. The fluid could be a cooling fluid used to cool the docked server 111 and prevent the docked server 111 from overheating. For instance, the fluid could be a liquid fluid or a gaseous fluid. However, in a currently contemplated embodiment, the fluid is air. For instance, in conventional datacenters, airflow is provided into the intake of a server thereby drawing heat away from the operating server 111. The flowrate source 131 might be, for instance, a fan. A flowrate driver 141 is configured to control the flowrate source 131 so as to control a flowrate of fluid 121 flowing into the fluid intake 112 of the docked server 111.

A user interface 150 is provided to allow a user to set properties of the fluid provided into the fluid intake 112 of the docked server 111. The user interface 150 includes a flowrate control 151 that the user may interface with to control the flowrate of the fluid flowing into the intake 112 of the docked server. The flowrate control 151 may control that flowrate directly or indirectly by controlling the amount of flow provided by the fluid flow source. In the indirect case, perhaps a significant amount of the fluid flow does not pass into the fluid intake 112 of the docked server 111. Alternatively or in addition, the flowrate driver 141 may make its own determination.

The server testing apparatus 100 may also be used to control a temperature of the fluid provided into the fluid intake 112 of the docked server 111. In this case, the fluid property source would be a temperature source 132 that is controlled by a temperature driver 142. The temperature driver 142 thermally couples the temperature source 132 to the fluid intake 112 of the docket server 111 to thereby control the temperature of the fluid 121 flowing into the fluid intake 112 of the docked server 111. The temperature source 132 might be, for instance, a heater and/or a cooler. To simulate a datacenter environment, in which servers are placed in close proximity, the temperature source would likely be a heater to simulate the elevated heat that is often present within a datacenter even with mitigation caused by airflow.

The user interface 150 also has a temperature control 152 that the user may interface with to set a temperature of the fluid at the fluid intake 112 of the docked server 111. In the case of other fluid properties being controlled at the fluid intake 112 of the docked server 111, there may be other controls (as represented by the ellipses 153) that allow the user to further control those additional fluid properties.

The server testing apparatus 100 has been described as controlling two properties (flow and temperature) of the fluid being fed into the intake 112 of the docked server 111. However, the server testing apparatus 100 may have one or more additional fluid property sources (as represented by the ellipses 133) that are controlled by respective drivers (as represented by ellipses 143) perhaps at the direction of respective controls (as represented by ellipses 153) of the user interface 150.

As examples only, humidity levels and contamination levels of the intake fluid may be controlled by additional humidity and contamination sources having respective controllers. For instance, the fluid property source 130 may include a humidification source (as represented by ellipses 133) that is controlled by a humidification driver (as represented by ellipses 143) perhaps be configured by a humidification control (as represented by ellipses 153) of the user interface 150. Alternative or in addition, the fluid property source 130 may include a contamination source (as represented by ellipses 133) that is controlled by a contamination driver (as represented by ellipses 143) perhaps be configured by a contamination control (as represented by ellipses 153) of the user interface 150.

Thus, the server testing environment 100 allows for very close simulation of the operation of a server in a target environment when the intake of the server is subject to multiple fluid properties, such as flow, temperature, humidity, contamination, or other fluid properties. Thus the fluid properties of the fluid flowing into the intake 112 of the docked server 111 may more accurately reflect the fluid properties that servers of that type or model might experience in the actual target environment. For instance, the internal fans may have different air draw while experiencing elevated temperatures in the thermal chamber versus room temperature during the airflow bench test. Accordingly, the testing of the server for endurance to such fluid properties is likewise more accurate. Furthermore, the server testing environment may simultaneously apply all of the fluid properties to the fluid intake at the same time, thereby reducing testing time as compared to conducting testing in several stages.

While the principles described herein are described as controlling fluid properties present for fluid at an intake of the server, the same principles may also be applied to additionally or alternatively control fluid properties (e.g., flowrate, temperature, and so forth) at other surface(s) of the server. This is represented by the arrow 122 in FIG. 1. As an example, a flowrate of the fluid 122 at the surface 113 of the docked server 111 may be generated by a flowrate source which may be the same or different than the flowrate source 131 used to provide flowrate at the inlet 112 of the docked server 111. Likewise, the temperature of the fluid 122 at the surface 113 of the docked server 111 may be generated by a temperature source which may be the same or different than the temperature source 132 used to provide flowrate at the inlet 112 of the docked server 111.

This type of simulation at other surfaces also may more accurately reflects the target environment. For instance, apart from the designed fluid intake typically at the front of a server, the server may also have holes or gaps in their casing that are induced by thermal and mechanical designs of the server. Such holes and gaps will also intake a lesser amount of air. Furthermore, the rack environment tends to be hotter than the server intake. Thus, by allowing for separate control of flowrate and/or temperature at other surfaces of the server (other than at the intake), even more accurate simulation of the target environment may be obtained. This even further improves the accuracy of the server testing.

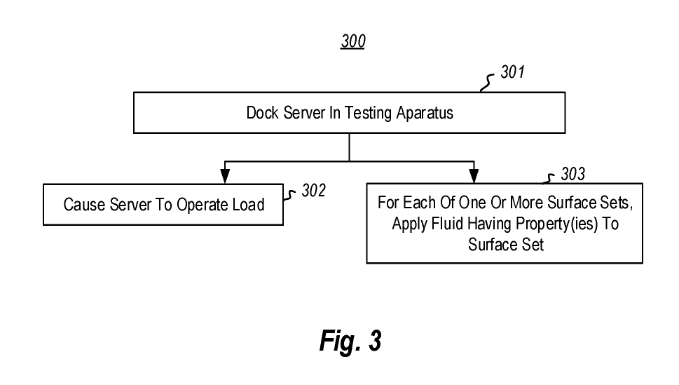

FIG. 2 illustrates a more specific example of a server testing apparatus 200 that represents a more specific example of the server testing apparatus 100 of FIG. 1. The server testing apparatus 200 has a docked server 211, which is an example of the docked server 111 of FIG. 1. The docked server 211 has internal fans, which are represented by the fan 202 in FIG. 2. FIG. 3 illustrates a flowchart of a method 300 for testing a server. As the method 300 may be performed with respect to the server testing apparatus 200 of FIG. 2, the remaining components of FIG. 2 will be described as the method 300 is being described. As the method 300 may be performed with respect to the server testing apparatus 100 of FIG. 1, the method 300 will also be described with frequent reference to the FIG. 1.

FIG. 3 illustrates a flowchart of a method 300 for testing a server. The method includes docking a server to a docking port (act 301). With respect to FIG. 1, the docked server 111 is docked within the docking port 110. With respect to FIG. 2, the docked server 211 is docked to a docking port (not shown) within the server testing apparatus 200.

Referring to FIG. 3, after the server is docked (act 301), the docked server is caused to operate a software load (act 302). This initiation of this software load may be performed by instructions to the server received through a communication interface created when the server was docked to the docking port. As previously mentioned, the application of this software load is meant to simulate operation of the server as it might operate within the target environment. The operation of the software load causes heat to be internally generated within the server, in similar quantities to how the server might internally generate heat when operating in its target environment (e.g., a datacenter).

For each of one of more surface sets of the server, fluid having one or more fluid properties is applied at the surface set (act 303). This may occur after a set temperature is set for the intake 212 of the server 211. For instance, in FIG. 1, the fluid 101 is applied at the fluid intake 112 of the docked server 111. That intake 112 is an example of a surface set. In the example described with respect to FIG. 1, this fluid applied to the fluid intake 112 has a controlled flowrate and temperature. The act 303 is shown in parallel with the act 302, because the principles described herein apply regardless of whether the fluid application is begun before or after or at the same time the docked server is caused to operate the software load (act 302). In one embodiment, the software load is not applied until the fluid is applied at the intake of the docked server, so as to prevent the docked server from heating up too much. However, this timing may not be critical where the fluid application is applied prior to the server heating up too much for too long.

With respect to FIG. 2 and act 303, fluid 201 is taken into the intake 212 of the docked server 211. The flowrate source 231 is an example of the flowrate source 131 of FIG. 1. The flowrate source 231 may be a fan or blower unit. As an example, the flowrate source 231 could be a variable-frequency drive or electronic control module fan or blower unit, and can be centrifugal or axial as appropriate for the size. In one embodiment, the flowrate source 231 has a maximum airflow capacity between 1500 and 2000 cubic feet per minute and can overcome static pressure drop by upstream obstructions.

The server testing apparatus 200 also includes a nozzle plate 203 calibrated according to AMCA standards with one to four nozzles to range the airflow from 100 to 2000 cubic feet per minute based on the combination of opened and closed nozzles, and speed of the flowrate source 231. As an alternative, a vane anemometer centered in channel can be used. Sets of airflow straighteners are provided before (see 204A) and after (see 204B) a temperature source 232 (described hereinafter), after the nozzle plate 203 (see 204C), and before the server intake 212 (see 204D). These airflow straightener sets are collectively referred to as “sets 204”). Airflow channels 205 (e.g., turning vanes) are provided after the nozzles plate 203 to distribute and expand the concentrated jet stream.

In this context, airflow driver 241 is an example of the airflow driver 141 of FIG. 1. The airflow driver 241 powers the flowrate source 231 and adjust the rate (e.g., rotations per minute) of the flowrate source 231 until the pressure ΔP₁ reading is zero with a certain PI dead band. Using the ΔP₂ reading, an airflow reading can be transuded (e.g., at the reading indicator 206 using the transuder 207). In this embodiment, the actual flowrate instructed to be applied to the server intake 212 is not a specific flowrate, but that flowrate that is required to keep up with the servers 211 ability to draw fluid.

Heat exchanger 232 includes two heat exchangers H1 and H2. The first heat exchanger H1 (which may be a water or refrigerant based heat exchanger or heater) to varies the air inlet temperature to the server. The heat exchanger H1 is an example of the temperature source 132 of FIG. 1. The Tin temperature controller 208A operates to turn off and on the heat exchanger H1 so as to cause the temperature of the fluid at the intake 212 of the docketed server 211 to be a set temperature. The Tin controller 208A is an example of the temperature driver 242 of FIG. 2.

In FIG. 2, a second surface set include the side surfaces 213A and 213B (collectively referred to as the side surfaces 213) of the server 211. The side surfaces 213 have holes 214A and 214B therein which represent the incidental holes that a server can have due to the mechanical and thermal design of the server 211. These incidental holes of much smaller that the fluid intake 212 of the server 211. Nevertheless, they do draw some warm fluid into the server 211 when operating in the target environment.

The second heat exchanger H2 varies the fluid temperature that are within chambers 215A and 215B at the side surfaces 213 of the server 211. The Tin temperature controller 209 operates to turn off and on the heat exchanger H2 so as to cause the temperature of the fluid at the intake 212 of the docketed server 211 to be a another set temperature, which may be different than (e.g., higher than) the set temperature for the fluid at the intake 212 of the server 211. This device can be upgraded with temperature, humidity, contamination stressing tools for more reliability oriented tests.

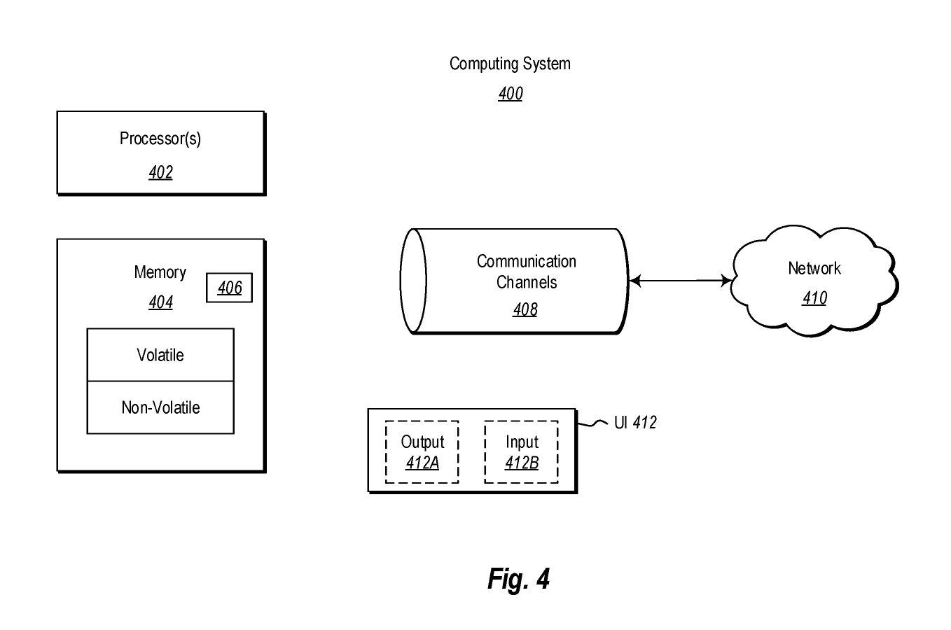

As described above, the user interface 150 may include a flowrate control 151, a temperature control 152, and other controls 153. These controls may be user interface components, and potentially underlying logic controls that allow set points to be set for fluid parameters. Because these controls may be implemented as an executable component within a computing system, a computing system will now be described with respect to FIG. 4.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses, watches, bands, and so forth). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 4, in its most basic configuration, a computing system 400 typically includes at least one hardware processing unit 402 and memory 404. The memory 404 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 400 has thereon multiple structures often referred to as an “executable component”. For instance, the memory 404 of the computing system 400 is illustrated as including executable component 406. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the term “component” or “vertex” may also be used. As used in this description and in the case, this term (regardless of whether the term is modified with one or more modifiers) is also intended to be synonymous with the term “executable component” or be specific types of such an “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 404 of the computing system 400. Computing system 400 may also contain communication channels 408 that allow the computing system 400 to communicate with other computing systems over, for example, network 410.

While not all computing systems require a user interface, in some embodiments, the computing system 400 includes a user interface 412 for use in interfacing with a user. The user interface 412 may include output mechanisms 412A as well as input mechanisms 412B. The principles described herein are not limited to the precise output mechanisms 412A or input mechanisms 412B as such will depend on the nature of the device. However, output mechanisms 412A might include, for instance, speakers, displays, tactile output, holograms, virtual reality, and so forth. Examples of input mechanisms 412B might include, for instance, microphones, touchscreens, holograms, virtual reality, cameras, keyboards, mouse or other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments can comprise at least two distinctly different kinds of computer-readable media: storage media and transmission media.

Computer-readable storage media include RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or components and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface component (e.g., a “NIC”), and then eventually transferred to computing system RAM and/or to less volatile storage media at a computing system. Thus, it should be understood that readable media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses or watches) and the like. The invention may also be practiced in distributed system environments where local and remote computing systems, which are linked (either by hardwired data links, wireless data links, or by a combination of hardwired and wireless data links) through a network, both perform tasks. In a distributed system environment, program components may be located in both local and remote memory storage devices.

Those skilled in the art will also appreciate that the invention may be practiced in a cloud computing environment, which is supported by one or more datacenters or portions thereof. Cloud computing environments may be distributed, although this is not required. When distributed, cloud computing environments may be distributed internationally within an organization and/or have components possessed across multiple organizations.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand, self-service, broad network access, resource pooling, rapid elasticity, measured service, and so forth. A cloud computing model may also come in the form of various application service models such as, for example, Software as a service (“SaaS”), Platform as a service (“PaaS”), and Infrastructure as a service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A server testing apparatus comprising:
a docking port in which a server may be docked and operated;
a fluid flow source;
a fluid flow controller configured to control a flowrate of fluid flowing into a fluid intake of the server when the server is docked in the docking port;
a heat source; and
a heat controller configured to thermally couple the heat source to the server to control a temperature of fluid flowing into the fluid intake of the server when the server is docked in the docking port.

2. The server testing apparatus in accordance with claim 1, the fluid being a gaseous fluid.

3. The server testing apparatus in accordance with claim 2, further comprising:
a humidification source; and
a humidification controller configured to control a humidification of fluid flowing into a fluid intake of the server when the server is docked in the docking port.

4. The server testing apparatus in accordance with claim 3, further comprising:
a user interface for setting a humidification level of the fluid flowing into the intake of the server when the server is docked in the docking port.

5. The server testing apparatus in accordance with claim 1, the gaseous fluid being air.

6. The server testing apparatus in accordance with claim 1, further comprising:
a user interface for setting a flowrate of the fluid flowing by the fluid flow source.

7. The server testing apparatus in accordance with claim 1, further comprising:
a user interface for setting a flowrate of the fluid flowing into the intake of the server when the server is docked in the docking port.

8. The server testing apparatus in accordance with claim 1, further comprising:
a user interface for setting a temperature of the fluid at the intake of the server.

9. The server testing apparatus in accordance with claim 1, further comprising:
a contamination source; and
a contamination controller configured to control a contamination of fluid flowing into a fluid intake of the server when the server is docked in the docking port.

10. The server testing apparatus in accordance with claim 1, further comprising:
a user interface for setting a contamination level of the contamination of the fluid flowing into the intake of the server when the server is docked in the docking port.

11. The server testing apparatus in accordance with claim 1, the heat controller being a first heat controller, the server testing apparatus further comprising:
a second heat controller configured to thermally couple a heat source to the server to control a temperature of fluid at a surface of the server other than the intake of the server when the server is docked in the docking port.

12. The server testing apparatus in accordance with claim 11, further comprising:
a user interface for setting a temperature of the fluid at a surface of the server other than the intake of the server when the server is docked in the docking port.

13. The server testing apparatus in accordance with claim 11, the heat source controlled by the first heat controller being a different heat source that is controlled by the second heat controller.

14. The server testing apparatus in accordance with claim 1, wherein the fluid flow source, the heat source, and the docking port are contained within a same capsule.

15. A server testing apparatus comprising a capsule that contains the following:
a docking port in which a server may be docked and operated;
an air flow source;
an air flow controller configured to control a flowrate of air flowing into an air intake of the server when the server is docked in the docking port;
a heat source;
a heat controller configured to thermally couple the heat source to the server to control a temperature of air flowing into the air intake of the server when the server is docked in the docking port; and
a user interface configured to allow a user to: 1) set a flowrate of the air flowing by the fluid flow source or flowing into the intake of the server, and 2) for set a temperature of the fluid at the intake of the server.

16. A method for testing a server, the method comprising:
docking a server into a docking port of a server testing apparatus;
causing the server to operate while the server is docked into the docking port; and
causing a controlled flowrate a fluid at a controlled temperature to flow from a fluid flow source into a fluid intake of the docked and operating server.

17. The method in accordance with claim 16, the fluid caused to be flowed also having a controlled humidification.

18. The method in accordance with claim 16, the fluid caused to be flowed also having a controlled contamination level

19. The method in accordance with claim 16, further comprising:
causing a fluid having a controlled temperature to also be present at at least one other side surface of the server.

20. The method in accordance with claim 19, the controlled temperature at the side surface of the server being different than the controlled temperature at the intake of the server.
